(19) United States
(12) Patent Application Publication
(10) Pub. No.: US 2011/0313090 A1
(43) Pub. Date: Dec. 22, 2011

(54) Method For The Manufacture Of Long Chain Phthalate Dialkyl Ester Compositions

(76) Inventors: Nicolaas A. De Munck, Barendrecht (NL); Raphael F. Caers, Edegem (BE); Didier Naert, Bruxelles (BE)

(21) Appl. No.: 13/123,582

(22) PCT Filed: Nov. 16, 2009
(86) PCT No.: PCT/EP09/65219

§ 371 Date: Sep. 1, 2011

(30) Foreign Application Priority Data
Nov. 24, 2008 (EP) 08169739.3

(51) Int. Cl. C08K 5/11; C11C 3/00

(52) U.S. Cl. 524/315; 554/148; 554/170

(57) ABSTRACT

An improved method for producing di-isotridecylphthalate (DTDP) is disclosed by esterification using a tetra-alkyl titanate catalyst made from preferably primary alcohols having at least 4 and preferably up to but not more than 10 carbon atoms. In the esterification process, compared to using tetra-isopropyl titanate catalyst, less of the alcohol from the catalyst contributes to the environmental burden associated with discarding the waste water byproduct, and more is incorporated into the prime DTDP product.

### CROSS REFERENCE TO RELATED APPLICATIONS

This application is a National Stage entry under 36 U.S.C. §371 of International Application No. PCT/EP2009/065219, filed Nov. 16, 2009, which claims the benefit of EP 08169739.3, filed Nov. 24, 2008, the disclosures of which are incorporated by reference in their entireties.

### FIELD OF THE INVENTION

The present invention relates to an improved process for the production of long chain phthalate dialkyl esters and the uses of the products thereof as lubricants and as plasticisers in applications that require a reduced volatility and/or a lower viscosity. The process for producing these phthalate esters is using specifically selected esterification catalysts.

### BACKGROUND OF THE INVENTION

C13 phthalate esters, such as di-isotridecylphthalate (DTDP), have found intensive use as plasticisers for polyvinyl chloride (PVC), besides less important end-uses such as lubricant or components in lubricant formulations, as hydraulic fluids or in hydraulic fluid formulations. C13 phthalate esters have a higher viscosity, which makes them more difficult to process, but bring the advantage of a lower volatility of the main di-ester components, when compared with phthalates having a lower molecular weight, such as di-2-propyl-heptyl phthalate (DPHP), di-isodecyl phthalate (DIDP) and di-isoundecyl phthalate (DIUP), di-undecyl phthalate (DUP) or di-undecyl-dodecyl phthalate (DUDP). The C13 phthalate therefore brings a higher permanence in its end-uses, in particular when exposed to elevated temperatures. By molecular weight, C13 phthalate esters compete with the trimellitate esters that are derived from shorter chain alcohols, such as tri-octyl-trimellitate (TOTM), but which are more difficult to produce and require trimellitic anhydride (TMA) as a building block, which is scarce compared to the phthalic anhydride that is used as raw material for a C13 phthalate ester.

Di-tridecyl phthalate esters are typically made from a starting alcohol or alcohol mixture comprising linear and/or branched C13 alcohol as a major component. The alcohol typically is a mixture of various isomers having the same carbon number and/or of alcohols having different, typically but not necessarily consecutive, carbon numbers. The alcohol may be reacted with (ortho-)phthalic acid, but more preferably phthalic anhydride is used as the starting material.

It is an industry standard to perform the esterification with an excess, as compared to the stoichiometric amounts necessary, of the starting alcohol, and to remove the water byproduct during the reaction in order to drive the reaction towards completion. A catalyst is typically introduced in order to increase the reaction rate. Organometallic catalysts, in particular tetra-alkyl titanates, have become the most widely used esterification catalysts. They are more selective to the desired ester, and suppress byproduct formation, in particular of di-alkyl ethers, during the esterification reaction. Chemically, the tetra-alkyl titanate catalysts are titanium alcoholates and have the formula Ti(OR)₄, wherein R represents the hydrocarbon group of the alcohol from which the titanate is typically derived.

Tetra-isopropyl titanate (TIPT) has become a frequently used titanium esterification catalyst in the commercial production of phthalate esters. TIPT is usually preferred over other tetra-alkyl titanates because a lower amount of catalyst is required for introducing the same amount of titanium. It is derived from isopropyl alcohol (IPA), which is a rather volatile and secondary alcohol.

Under the reaction conditions for producing the phthalate ester, the alcohol in the titanate catalyst is exchanged with the alcohol that is present as raw material for the product ester, whereby the alcohol from the titanate is liberated. When a propyl-containing titanate is used, such as TIPT, an amount of propanol becomes liberated in the reaction mixture. Under the reaction conditions, a volatile alcohol such as propanol may be removed as vapour from the reacting mixture and may be condensed in the overhead system of the esterification reactor system. A portion thereof may be recycled with the alcohol reflux to the esterification reactor, but another portion may be removed with the water byproduct stream that is typically withdrawn from the overhead system of the esterification reactor and usually discarded as waste water. We have found that low molecular weight alcohols, such as isopropanol, typically for a major portion end up in the discard water stream. The alcohol dissolved in this waste water stream creates an extra environmental burden because of its strong contribution to the Biological Oxygen Demand (BOD) load of this waste water stream.

We have now found that a part of the alcohol that is liberated from the titanate catalyst may participate in the esterification reaction. Due to the large excess of the main alcohol, which is present as raw material for the product phthalate ester, this participation leads almost exclusively to the formation of a phthalate co-ester having an alkyl group of the main alcohol component on the first ester function, and having an alkyl group of the alcohol from the titanate catalyst on the second ester function. We have also found that this co-ester, when it is formed, typically remains in the phthalate ester final product. We have also found that a phthalate dialkyl ester having both alkyl groups from the alcohol of the titanate catalyst is not formed to any significant level.

GB 1301312 discloses phthalate esters made of Dobanol 23, which is an equimolar mixture of normal dodecanol and normal tridecanol, and a phthalate made from branched isomeric primary alcohols alone, labelled as DTDP. Topanol CA, described as a phenolic antioxidant, was added in an amount of 0.5% wt to the plasticiser. GB 1301312 does not disclose the esterification catalyst that was used for the production of its phthalate esters. The phthalate esters of GB 1301312 may be made using sulphuric acid or toluene sulphonic acid as the esterification catalyst, and without using a tetra-alkyl titanate. The esters of this document therefore are not expected to contain any co-ester of the alcohols of the parent ester and the alcohol of a titanate catalyst.

U.S. Pat. No. 6,982,295 B2 discloses plasticizers, in particular phthalates, based on less branched C13 alcohols. The esterification process producing these phthalates is preferably conducted in the presence of a catalyst. Typical esterification catalysts are titanium, zirconium and tin alcoholates, carboxylates and chelates. Selected acid catalysts may also be used in this esterification process.

WO 2006/125670 discloses a C6 to C13 phthalate ester containing from 50 to 2500 ppm by weight of a co-ester in which the second ester bond is made with an alcohol having at least 2 carbon atoms more or at least 2 carbon atoms fewer than the main alcohol. According to this document, co-ester levels above 1000 ppm are less preferred because in a C10 phthalate, e.g. a C10/C4 co-ester may contribute to the light scattering film (LSF) or fogging performance of the plasticiser and of articles made therewith. Other background references include WO 02/02499, EP 0 424 767 A, and U.S. Pat. No. 5,880,310.

Light scattering film (LSF) and fogging performance of the plasticiser has become an important characteristic for any product used in the automotive industry. LSF performance of a plasticiser, or of an interior trim material or article used in automobiles and other vehicles, is an important product characteristic for the US market. It may be determined according to US Automotive Specifications using a test method such as ASTM D5393, GM 9305P, Ford method FLTM BO 116-3 or SAE J1756. Fogging performance of a plasticiser may also be determined using test method DIN 75201 (DIN EN 14288 or ISO 6452), which is typically used as an important product characteristic in Europe. We have found that the performance of the phthalate plasticisers in these tests is strongly affected by the presence of “intermediates” in the ester. The term “intermediates” in this context represents the family of impurities that elute, in a boiling point gas chromatograph (GC) analysis of the ester, after the main alcohol but before the product ester. More details about a suitable analytical GC method, and the nature of impurities that occur as impurities in phthalates, is found in WO2005/021482. These intermediates are typically present at levels in the range of 300-2000 ppm by weight based on the total ester product.

A significant part of these intermediates may be di-alkyl ethers, which are formed as byproducts during the esterification reaction. Also di-alkyl esters may be formed, but these are typically considered included into the di-alkyl ether impurity levels. Titanates are preferred as esterification catalysts, because they lead to lower levels of di-alkyl ether byproducts and thus to better product performances in the LSF or fogging tests. We have found that the C10/C4 phthalate co-ester, which may be present in the C10 phthalate of WO 2006/125670, is less volatile than the di-C10 ethers which are also typically present. When a C10 phthalate plasticiser is submitted to a test for volatiles, such as the LSF or fogging tests already mentioned, the di-C10 ethers are found to be stronger contributors to a less desired test reading than a C3/C10 or C4/C10 co-ester derived from the use of a C3 and/or C4 titanate catalyst during the esterification.

U.S. Pat. No. 7,300,966 B2 discloses phthalate di-esters made from alcohol mixtures consisting of decanols and tridecanols in a molar ratio ranging from 70:30 to 30:70, employing an esterification process that uses isopropyl butyl titanate as a catalyst. Isopropyl butyl titanate catalysts are available as commercial products, in which case they are based on 80% or even 85% by weight of isopropanol, the balance being butanol. The amount of butyl groups present is sufficient to reduce the melting point of the titanate such that the catalyst remains liquid at ambient temperature. Isopropyl butyl titanate catalyst thus introduces a significant amount of isopropanol into the reacting mixture. The phthalate ester mixtures disclosed in U.S. Pat. No. 7,300,966 B2 therefore are expected to contain an amount of the light co-ester having an isodecyl or an isotridecyl group as the first alkyl group of the ester and isopropyl as the second alkyl group. Based on the amount of catalyst used and the amount of isopropyl groups introduced thereby, there may be up to more than 1700 ppm by weight of esters having isopropyl as at least one of the alkyl groups of the esters disclosed in U.S. Pat. No. 7,300,966 B2. A significant portion of these co-ester byproducts will also have an isodecyl group as the first alkyl group, and thus be more volatile than those having an isotridecyl group instead. In addition, the phthalate di-esters of U.S. Pat. No. 7,300,966 B2 are expected to contain di-C10 and C10/C13 di-alkyl ethers as further intermediates, and which are even more volatile than the di-C13 ethers which are also expected.

The building industry has recently also become sensitive to indoor air quality, and the emission of volatile organic carbons (VOCs) and also semi volatile organic carbons (SVOCs) from building interior parts. Performance tests have been developed for such parts or for ingredients intended therefore, as well as acceptance criteria for their emission of VOCs or SVOCs. Examples are the European ENV-13419-3 standard or the Nordtest NT Build 438 standard. The ENV-13419 Standard has recently been revised and published under ISO 16000-9 to 11, such that ENV-13419-2 (Flec Cell) has now become ISO 16000-10 and ENV-13419-3 has now become ISO 16000-11. PVC plasticisers, such as phthalates, may be subjected to these tests and may need to comply with these criteria for being accepted for use in building interior parts, such as vinyl flooring and wallpaper, but also synthetic leather and wire and cable insulation.

The automotive industry is more recently also showing an increased sensitivity to the emission of VOCs from car parts during the life of the car, because of their potential effect on air quality in the passenger compartment, in particular in terms of odour formers and other possible pollutants. Increased awareness of the car indoor environment is creating a demand for low-emitting construction materials also for car parts. This applies to car interior trim parts in the first place, but may also apply to under-the-hood car parts, because of the higher temperature these parts are typically exposed to, and air from under the hood may find its way also into the passenger compartment. New performance tests have been introduced, and corresponding VOC acceptance criteria start to be applied. Examples are for car part ingredients the VDA 277 test (so-called Total VOC determination by an organic emission test with a static headspace), and for the car parts themselves the VDA 278 test (the “Daimler-Chrysler-method” based on thermodesorption with a dynamic headspace). Various definitions may be in use. Some authority in this context has been gained by the World Health Organisation, which defines VOCs as compounds having an atmospheric boiling point in the range from 50° C. to 250° C. and SVOC from 240° C. to 400° C. The European Union in its legislation applies as definition for VOC's comprising all substances with a vapor pressure of above 0.01 kPa at 293.15° K (20° C.). The Daimler-Chrysler PB VWL 709 or VDA 278 thermodesorption test distinguishes between VOCs and FOGs. As VOCs are defined all substances eluting into a helium stream over 30 minutes time, and counted in μg/g of sample as toluene equivalent, when exposing a 30 mg sample to a temperature of 90° C. This would include all hydrocarbons from pentane (C5 alkane) up to approximately eicosan (nC20 paraffin). As FOGs are defined all substances eluting into a helium stream over 60 minutes time, and counted in μg/g of sample as hexadecane equivalent, when exposing again a 30 mg sample to a temperature of 120° C. This would include all hydrocarbons from n-hexadecane (C16) up to at least a nC32 alkane.

These tests for the emission of volatile organics in some or other definition are now starting to be applied also to furniture and fabrics. More and more of the flexible PVC articles, such as synthetic leather, and their ingredients such as plasticisers, are coming under scrutiny and have their performances in these tests measured.

We have now found that in the production of a C13 phthalate ester using a titanate catalyst containing propyl groups such as TIPT or Isopropyl Butyl Titanate, a C3-C13 phthalate co-ester may be formed, and that a significant amount of this co-ester remains in the C13 phthalate product. We have also found that the C3-C13 co-ester has about the same volatility as the di-C13 ether byproduct that is also made during the esterification process. We have also found that significant amounts of these byproducts may remain in the product of a typical esterification process, and that these byproducts contribute significantly to the effects measured in the volatility tests previously mentioned, particularly in the more sensitive tests. With a C13 phthalate, the C3-C13 phthalate co-ester may therefore make a more significant contribution to for instance the LSF or fogging performance, or to the effects measured in the LSF or fogging tests, than the di-C13 ether byproduct from the esterification reaction. C13 phthalate esters are especially preferred over their lower molecular counterparts because of the lower volatility of the main ester, and they are particularly used in the production of high temperature electrical cabling, such as harness wire or under-the-hood automotive cables. They may also be used in car interior trim parts, and in articles intended for use inside buildings. It is therefore important to minimise the contribution of more volatile impurities, typically present in the C13 phthalate, to the volatility measurements as applied in these sensitive end-uses.

We have also found that when a titanate alcoholate catalyst containing a highly volatile alcohol group is used in the esterification, a part of this volatile alcohol ends up in the waste water collected in the overhead of the esterification apparatus. In particular when a titanate catalyst containing propyl groups such as TIPT or Isopropyl Butyl Titanate is used, a large portion of the isopropyl alcohol (IPA) is found in the waste water, where it creates a significant waste water treatment burden because the biological oxygen demand (BOD) associated with the presence of the IPA typically must be reduced before the waste water can be discarded. We have also found that with these titanate catalysts containing propyl groups, the propyl alcohol preferentially ends up in the waste water, which is a loss of potentially valuable molecules from the process.

We have further found that when the titanate catalyst is made from a secondary alcohol, such as TIPT or Isopropyl Butyl Titanate being solely or primarily based on isopropanol, this secondary alcohol has a lower tendency to participate in the esterification reaction and lead to a co-ester in the main product. A light secondary alcohol, such as isopropanol, was found to have a particularly strong preference to end up in the waste water stream of the process, and be lost from the process. Therefore a need remains for a process to produce a C13 phthalate ester of which the contained impurities that are more volatile than the product ester are having a reduced impact on the effects measured in the volatility tests applied in the end-use applications where the C13 phthalate ester is used, in particular in the automotive, the building and/or the wire-and-cable industry, and more particularly for use in car interior trim parts, in building interior parts, and in wire and cable such as under-the-hood electrical cabling.

A C13 phthalate ester typically has a significantly higher viscosity as compared to its lower molecular weight equivalents, such as DIUP, DIDP, DUP and DUDP mentioned before. This high viscosity is a drawback when the ester is processed in the downstream transformation processes. There therefore remains a need to provide a process for producing a C13 phthalate ester having a reduced viscosity, and small reductions may already be highly appreciated.

The product of the invention provides such a process for producing a C13 phthalate ester.

There also remains a need for a process for producing a C13 phthalate ester using a titanate catalyst wherein less of the valuable alcohol from the catalyst ends up in the waste water stream where it significantly contributes to the environmental burden of the process. The process of the invention reduces this environmental burden and converts more of the alcohol from the catalyst into valuable product.

### SUMMARY OF THE INVENTION

The invention provides a process for producing a phthalate dialkyl ester composition comprising the reaction of phthalic acid and/or phthalic anhydride with an alcohol or alcohol mixture having a nominal average carbon number from 12 to 14, preferably 13, in the presence of a tetra-alkyl titanate esterification catalyst of formula Ti(OR)₄ in which the R groups are alkyl groups having a nominal average carbon number of at least 4.

The tetra-alkyl titanate catalyst is conveniently substantially free of propyl alcoholate groups, in particular free of isopropyl alcoholate groups.

The ester composition produced by the process according to the invention brings the advantage that the average phthalate dialkyl ester, which may be formed during the reaction and which comprises at least one R group of the catalyst, is less volatile than in DTDP made with conventional titanate catalysts containing isopropyl groups. The phthalate dialkyl esters formed as byproducts are esters in which one of the ester functions has as first alkyl group from the alcohol or alcohol mixture having an average carbon number from 12 to 14, and the other ester function has a second alkyl group from the alcoholate part of the tetra-alkyl titanate catalyst. The ester composition produced according to the invention contains low amounts of, and is preferably free of, co-esters having a propyl ester group as the second alkyl group, in particular an isopropyl ester group.

The alkyl alcoholate groups of the tetra-alkyl titanate catalyst are conveniently primary alkyl alcoholate groups; conveniently at least for 25% by weight, but more conveniently at least 30% or even at least 50% by weight, yet more conveniently at least 75% by weight and most conveniently at least 90% by weight of the alkyl groups of the titanate catalyst are primary alkyl groups, relative to the total of alkyl groups of the titanate catalyst and determined on the alcohol or alcohol mixture obtained after hydrolysis of the titanate.

We have found that the primary alcohols obtainable from the alkyl alcoholate groups of the titanate catalyst have a higher tendency than other alcohols, such as secondary or tertiary alcohols, to participate in the esterification reaction and to lead to the formation of the co-ester. This brings the advantage that a higher portion of the alcohol part of the catalyst is incorporated into the prime ester product, instead of discarded with the waste water where it represents an environmental burden. We have also found that the relatively small amount of co-ester that may be present in the C13 phthalate ester product surprisingly also may bring an advantage by reducing the viscosity of the ester product.

The performance of the phthalate ester composition produced according to the invention may be improved over a similar ester that is based on TIPT, when the composition is subjected to at least one of the LSF, fogging, VOC or SVOC emission, or other volatility tests mentioned above.

The phthalate dialkyl esters that are present in the composition produced according to the invention have a first alkyl group on one of their ester functions and a second alkyl group on their second ester function.

In an embodiment, the second alkyl group has an average carbon number of at most 10. The phthalate ester composition produced in this embodiment of the invention provides an acceptable compromise between the product volatility requirements and the processing requirements, in particular of the titanate catalyst.

In another embodiment, the invention provides for a process for producing a C12-C14, typically a C13, phthalate ester composition comprising as a major component a phthalate dialkyl ester with both alkyl groups having a nominal average carbon number of from 12 to 14, said composition, relative to the total weight of the composition, and the composition further comprising (i) less than 500 ppm by weight of a phthalate dialkyl ester having a propyl group as at least one of the alkyl groups, preferably less than 100 ppm by weight, more preferably less than 50 ppm by weight and most preferably less than 10 ppm by weight, and (ii) from 10 to 2500 ppm by weight, preferably at least 50 ppm, more preferably at least 100 ppm and most preferably at least 500 ppm by weight of a phthalate dialkyl co-ester in which one of the ester functions has a first alkyl group having a nominal average carbon number of from 12 to 14 and the other ester function has a second alkyl group having a nominal average carbon number of at least 4. The second alkyl group preferably has an average carbon number of at most 10.

The selection of the catalysts according to the present invention offer many advantages, including the fact that the titanate catalyst has a lower viscosity than with R groups having carbon numbers higher than 10, and is therefore easier to handle without needing dilution with a solvent.

The use of an esterification catalyst made from an alcohol having a nominal average carbon number of at least 4 carbon atoms causes the average co-ester in the C13 phthalate product according to the invention to be less volatile as compared to when a titanate primarily based on isopropanol is used as the catalyst.

The alcoholate groups of the titanate catalyst are conveniently primary alcoholate groups, as explained before, rather than secondary or tertiary alcoholate groups.

The phthalate dialkyl ester manufacturing process according to the invention has a lower environmental burden than prior art processes because the waste water from the process contains less of the alcohol that is introduced with the alcoholate groups of the titanate catalyst, as compared when the titanate catalyst contains propyl alcohol groups. A further advantage of the process of the invention is that more of the alcohol groups of the titanate catalyst are incorporated into the valuable ester end-product rather than lost into the waste water byproduct.

The process of the invention further comprises the use of the phthalate diester composition produced by the process of the invention as a plasticiser for or with polyvinyl chloride (PVC), more especially in car and automotive, boat, interior trim or wire-and-cable applications, and more particularly in under-the-hood wire-and-cable applications. The process of the invention therefore also comprises shaping a flexible PVC article which comprises the phthalate dialkyl ester composition.

The phthalate diester composition produced according to the invention has a reduced contribution to VOC and/or SVOC emissions from the plasticised PVC article made therewith. This is particularly important in interior trim and soft touch parts and cover applications, such as for clean room applications or in the automotive, boat or aeronautic industry, as well as in wire-and-cable applications, and more especially for under-the-hood applications.

The invention further provides for the use of the phthalate diester composition produced by the process of the invention as a plasticiser for reducing the emission of volatile organic compounds, in any of the definitions of VOCs, SVOCs or FOGs such as those mentioned above from articles, or for improving the LSF or fogging performance of articles, made from PVC plasticised with the C23 phthalate ester composition. This use may occur, in particular for interior trim articles, in servicing the automotive, boat or aeroplane industry, or in setting up of clean rooms.

The invention further provides for the use of the phthalate diester composition produced by the process of the invention as a lubricant or as a lubricant component, or as a hydraulic fluid or as a hydraulic fluid component.

The invention further provides for producing an article, such as an interior trim part or a soft touch part or cover for the automotive, boat or aeronautic industry, such as a dashboard or dashboard cover, an ABC column or ABC pillar cover, a sun visor, an armrest, a middle console part or cover, a door panel or a door trim cover or article, a steering wheel cover, an airbag door cover, a gear cover, a seat cover or a back seat cover, a headliner, a rear or parcel shelf, or for an electrical cable comprising electrical insulation or for an electrical cable formulation serving as an intermediate thereto, which comprises PVC plasticised with the phthalate diester composition produced by the process according to the invention.

The article, part or cover or the electrical cable according to the invention has a reduced contribution to emissions into the air during its product life. This is becoming increasingly important in the building, the automotive and wire-and cable industry, and in particular in under-the-hood wire-and-cable applications.

### BRIEF DESCRIPTION OF THE DRAWINGS

FIG. 1 shows a light-ends GC spectrum of a conventional DTDP (Jayflex® DTDP) produced with TIPT as the esterification catalyst.

### DETAILED DESCRIPTION

The phthalate diester composition produced by the process according to the invention is produced by an esterification process using a tetra-alkyl titanate as catalyst. This brings the advantage, compared to the use of other types of catalysts such as para-toluene sulphonic acid (pTSA) or sulphuric acid, that the product of the process is containing less dialkyl ethers as byproducts. The ester is produced by the reaction of phthalic acid and/or phthalic anhydride with an alcohol or alcohol mixture having a nominal average carbon number from 12 to 14. This brings the advantage that the ester itself has a lower volatility and a higher permanence, particularly in end-uses where exposure to higher temperatures may occur, relative to phthalate diesters having a lower molecular weight. The tetra-alkyl titanate catalyst having the feature as specified is based on an alcohol having a higher average carbon number, and brings the advantage that the phthalate co-ester with the alcohol from the catalyst has a lower volatility, as explained before.

The phthalate diester composition produced by the process according to the invention conveniently contains less than 50 ppm by weight of a phthalate dialkyl ester having a propyl group, typically an isopropyl group, as at least one of the alkyl groups and more preferably comprises from 50 to 2500 ppm by weight of a phthalate dialkyl co-ester in which one of the ester functions has a first alkyl group having a nominal average carbon number of from 12 to 14 and the other ester function has a second alkyl group having a nominal average carbon number of at least 4 and preferably at most 10. In one embodiment, the composition comprises from 50 to 2500 ppm by weight, preferably from 100 to 2000 ppm by weight, more preferably from 200 to 1500 ppm by weight, even more preferably from 300 to 1200 ppm by weight and most preferably from 500 to 1000 ppm by weight of such phthalate dialkyl co-ester, the weight contents being expressed based on the total weight of the phthalate dialkyl ester composition.

The amount of the phthalate dialkyl ester having a propyl group as at least one of the alkyl groups, and of the phthalate dialkyl co-ester in which one of the ester functions has a first alkyl group having an average carbon number of from 12 to 14 and the other ester function has a second alkyl group having an average carbon number of at least 4 and preferably at most 10, may be determined by light ends gas chromatography (GC), if needed combined with mass spectrometry (GC-MS).

As an alternative, the relative amounts of these alkyl groups may be determined by analysis of the alcohol obtained by hydrolysis of the total phthalate dialkyl ester composition, by methods known in the art. Special attention must be given to include the amounts of alcohol, particularly the lower molecular weight alcohols such as isopropanol, which may become dissolved in the aqueous phase involved in such ester hydrolysis treatment. For determining the carbon numbers of the alkyl groups of the alcohol functions involved, the alcohol composition from the hydrolysis may be analysed by GC, more preferably by GC-MS. The alcohol composition from hydrolysis may optionally first be silylated before the analysis by GC or GC-MS. The alcohol composition may also, optionally after first being separated in fractions by distillation, be analysed by ¹H-NMR such as explained further herein.

For the phthalate dialkyl co-esters having one of their ester function with a first alkyl group having a nominal average carbon number of from 12 to 14 and the other ester function having a second alkyl group having a nominal average carbon number of at least 4 and preferably at most 10, these second alkyl groups may be straight chain (or linear), and/or may be a branched alkyl groups. The second alkyl groups may be mixtures of alkyl groups having different branching structures, derived from different alcohol isomers that may be present in the titanate catalyst.

Examples of second alkyl groups include n-butyl, isobutyl (also called 2-methyl propyl), 1-methyl propyl, or tertiary butyl (1,1-dimethylethyl), or a mixture thereof. Preferably the second alkyl groups are a mixture of n-butyl and isobutyl groups.

In one embodiment, the second alkyl groups of the dialkyl co-esters have an average carbon number of at least 5. This will further reduce the volatility of the co-ester and improve the acceptance of the phthalate dialkyl ester composition in the sensitive applications.

The second alkyl group may thus also be n-pentyl, 2-methyl butyl, 3-methyl butyl (isopentyl), 1-methyl butyl, 1,2-dimethyl propyl, 1-ethyl propyl, or mixtures thereof. Less preferably, the second alkyl group may also be tertiary amyl.

In another embodiment, the second alkyl groups of the phthalate dialkyl co-esters have an average carbon number of at least 6, preferably at least 7, more preferably at least 8. For further reduction of the volatility, even higher carbon numbers, such as at least 9, or 10, or even higher would be preferred.

A titanate catalyst having alkyl groups with more carbon atoms has a higher viscosity than a similar catalyst with less carbon atoms in the alkyl groups. We have found that titanate made from alcohols having more than 10 carbon atoms have the disadvantage that they are highly viscous for easy handling as such. In addition to their reduced titanium content, requiring more catalyst for introducing the same amount of titanium, such high molecular weight titanates typically require the use of a solvent or carrier to enable easy handling, storage and pumping of the titanate, such as for injecting the catalyst into the esterification reactor.

Commercially available alcohols having such average carbon numbers are often obtained by hydroformylation, or by other processes that produce primary alcohols, such as Ziegler alcohols. However, we have found that the titanate catalysts made with such higher carbon number alcohols become more and more viscous, and we prefer to use an alcohol with a nominal average carbon number of at most 10. This results in phthalate dialkyl co-esters of which the second ester alkyl group correspondingly have an average carbon number of at most 10. Examples of suitable second alkyl groups having at most 10 carbon atoms include those originating from alcohols such as 2-propyl heptanol, typically obtained by butene hydroformylation and aldolisation of the n-pentanal intermediate, which leads to co-esters having primarily a 2-propyl heptyl alkyl group connected to the second ester function. Another suitable alcohol is isodecyl alcohol, a mixture of primarily C10 branched alcohols obtained by the hydroformylation of a nonene mixture and leading correspondingly to a variety of second alkyl group structures in the co-esters of which the first alkyl group has the average carbon number of from 12 to 14 obtained from the parent alcohol of the dialkyl phthalate of the invention.

We have also found that incorporation in the diester of alkanolate groups originating from the titanate catalyst is more important when the alkyl groups of the titanate catalyst are primary alkyl groups. Alcohols obtained by hydroformylation are by definition primary alcohols, and are thus preferred. A higher incorporation of the alcohol of the titanate catalyst into the product ester will improve the environmental performance of the esterification process and will also improve the viscosity of the product ester. Tetra-alkyl titanates obtained from primary alcohols, such as those obtained by the hydroformylation of olefins, are thus preferred.

A very suitable balance of properties of the phthalate dialkyl ester on one hand and of the titanate catalyst on the other hand is provided by primary alcohols or alcohol mixtures having an average carbon number of at least 7.9 and at most 9.3, such as n-octanol, 2-ethyl hexanol, or 3,5,5-trimethyl hexanol, optionally in high isomeric purity such as at least 80% wt, preferably at least 90% wt and more preferably 95% wt purity, or alcohols with a lower isomeric purity such as isooctanol or isononanol, which may also contain minor portions of alcohols having one more and/or one less carbon atoms in their molecule as their name would suggest. Mixtures of these alcohols may also be used.

When alcohol mixtures are used in the context of this invention, the alcohols in the mixtures may have the same or different carbon numbers. They may also have different alkyl structures. The carbon number or a carbon number distribution of such an alcohol mixture may be determined by methods known in the art. A suitable capillary gas chromatography (GC) method is disclosed in WO 2006012989. For alcohol mixtures having up to C9 and even C10 carbon numbers, this method is readily applicable. In order to improve the GC resolution for higher carbon numbers, a silylation technique may be employed as part of the method, such as disclosed by Kovacs (Z. Anal. Chem. 181, (1961), p. 351; Adv. Chromatogr. 1 (1965), p. 229). Higher carbon number alcohol mixtures, in particular when alkyl groups of high branchiness are involved, may have unacceptably high overlap between individual carbon numbers in the GC-spectrum, even when silylated, in which case we prefer to use a ¹H-NMR technique to determine an average carbon number, provided the mixture is sufficiently rich, such as at least 95% by weight, in alcohols, and the mixture is lean in unsaturated compounds, as may be determined by bromine or iodine value, and carbonyl number. Commercial alcohol mixtures typically comply with these requirements. In this technique, the average carbon number of an alcohol mixture may be determined by employing the integration of all protons of the CH, CH₂ and CH₃ groups relative to the integration of the —CH₂O-protons. The ¹H-NMR technique also allows determining the average branchiness of the alcohol groups, i.e. the average number of side branches on the main carbon chain of the alkyl group, as is also explained in WO 2006/012989. When an average carbon number is determined for a mixture of similar compounds containing an alkyl group, such as an alcohol mixture in the context of the present invention, it is customary to round the result up or down to the nearest integer. The integer that is the result of the rounding is then commonly called the nominal average carbon number of the mixture. For single isomer compositions or for isomer mixtures having the same carbon number, the nominal average carbon number is the same as the average carbon number or of the carbon number.

The titanate catalysts suitable for the present invention may thus conveniently have alkyl chains having a nominal average carbon number of 8, 9 or 10. A suitable titanate catalyst may be produced using 2-propyl-heptyl alcohol, and thus have at least one 2-propyl-heptyl alkyl chain. We prefer the titanate catalyst to be made from primary alcohols, because of the higher stability of the dialkyl co-ester made with the alkyl alcoholate group provided by the catalyst. The resulting phthalate dialkyl esters may thus comprise co-esters of which the second alkyl group has a nominal average carbon number of 8, 9 or 10.

A particularly suitable family of primary alcohols for the titanate catalyst are the C7-C10 Oxo alcohols commercially provided by ExxonMobil Chemical under the trade name Exxal® alcohols. An overview of their typical carbon number distribution and average carbon number is shown in Table 1.

TABLE 1

| Wt % | Carbon Number | | | | | | | | | |
|---|---|---|---|---|---|---|---|---|---|---|
| Alcohol | 6 | 7 | 8 | 9 | 10 | 11 | 12 | 13 | 14 | Average |
| Exxal 7 | 4 | 83 | 13 | | | | | | | 7.1 |
| Exxal 8 | | 2 | 90 | 8 | | | | | | 8.1 |
| Nonanol* | | | | 100 | | | | | | 9.0 |
| Exxal 9 | | | 3 | 72 | 25 | | | | | 9.2 |
| Exxal 9S | | 1 | 2 | 94 | 3 | | | | | 9.0 |
| Exxal 10 | | | | 4 | 89 | 7 | | | | 10.0 |
| Exxal 11 | | | | | 13 | 81 | 6 | | | 10.9 |
| Exxal 12 | | | | | | 10 | 80 | 10 | | 12.0 |
| Exxal 13 | | | | | | 7 | 30 | 60 | 3 | 12.6 |

*Typical 3,5,5-trimethylhexanol content 80% wt.

Processes for the production of oxo alcohols may comprise pumps which operate in a service wherein the pump internals are prone to fouling. These services may be critical and particularly demanding, especially when outlet pressure is high, such as 50, 200 or even 300 barg, and/or when hydroformylation catalyst may be present. Examples are feed pumps for the hydroformylation reactors, for hydroformylation catalyst preforming reactors, for decobalters, or for the hydrogenation reactors that may be following downstream of the hydroformylation step. We have observed that minute amounts of fouling material may deposit on the pump internals and impair the pump efficiency, and lead to an increase of the power requirements of the pump driver for delivering the same amount of liquid at the same outlet pressure. Conversely, such fouling may lead to a reduction of the pump performance for the same power consumption of the pump driver, which may be limited. We have found that very small amounts of fouling may cause significant increases in power consumption and/or reduction of throughput capacity, and may also lead to an increased frequency of pump trips and associated process upsets, and ultimately call for additional investment in pumping capacity. We have also found that the sensitivity of a pump to fouling increases with the rotational speed the pump is operating at.

We have now found that a surface treatment, smoothening the internal surfaces of some of the pump internals, even partly such as of the pump diffuser and/or the casing, optionally also of the pump impeller such as in a centrifugal pump, may bring immediate improvements in pumping efficiency and/or capacity, and may also extend these benefits over the longer run. The smoothening effect is preferably obtained by a polishing treatment, and this may be performed manually or by electro-polishing, which is easier for surfaces having irregular and/or complex shapes. For example, we found that polishing of the pump diffuser and housing of a Sundyne centrifugal pump, operating at 18000 rpm in hydrogenation feed service and delivering decobalted hydroformylation product at a pressure of about 60 barg, led to a 8% reduction of the electrical power drawn by the electric motor driving the pump as compared to a standard pump in the same service. When fouling of the pump leads to excessive power consumption and impairs the capacity of the pump, the pump is taken out of service for cleaning. This cleaning can be done mechanically after opening the pump housing, using light abrasive materials or alternately, by applying an acid wash of the pump. A method for applying an acid wash treatment for removal of cobalt metal or clusters from a hydroformylation reactor is explained in WO 2005/058787, and it may be suitably modified and applied on pumps and exchangers as well. Similar to the reactor disclosed in the referenced document, we also prefer to use Duplex stainless steel as the construction material of the pump, because of its resistance to corrosive process conditions and the acid wash conditions.

In an embodiment, we use tetra-isooctyl titanate (TIOT) produced from Exxal® 8 alcohol as the esterification catalyst, as we have found that this provides the best balance in properties of the catalyst and of the resulting co-ester, as well as of the final product ester composition. We have found that a significant amount of the isooctyl alcohol from the titanate may be retrieved in the product ester, as alcohol fragments of phthalate esters, and which may be identified by saponification of the product ester and analysing the resulting alcohol composition.

We prefer the titanate catalyst, in particular the TIOT, to contain only insignificant amounts of 2-ethyl hexyl groups, because of the toxicity concerns that are associated with di-2-ethyl-hexyl phthalate (DEHP, also known as DOP), and in particular its mono-ester. In an embodiment, the alkyl alcoholate groups of the titanate catalyst, and thus also the second alkyl groups of the dialkyl co-ester present in the phthalate dialkyl ester composition of the present invention, contain at most 1% by weight, preferably at most 0.1% by weight, more preferably at most 100 ppm by weight and most preferably at most 50 ppm by weight of 2-ethyl-hexyl groups, relative to the total of the alkyl alcoholate groups of the tetra-alkyl titanate, or to the total of the second alkyl groups of the phthalate dialkyl co-ester.

The concentration of the phthalate di-alkyl co-esters in the phthalate dialkyl ester composition may be readily determined using a boiling point or capillary gas chromatograph technique as explained further in this document.

The carbon number, and where possible the structure, of the second ester alkyl group of the phthalate dialkyl co-esters may more readily be determined by first hydrolysing or saponifying the phthalate dialkyl ester composition, separating the alcohol organic fraction, and analysing the resulting alcohol fraction or a selected portion that is conveniently distilled thereof. With the lighter alcohols up to C5, as well as with higher alcohols that have high isomeric purity, the alkyl group structure may be determined using gas chromatography (GC), optionally combined with mass spectrometry (GCMS). Heavier and more complex alcohol mixtures are preferably first separated from the main parent alcohol of the ester composition, such as by distillation, and may then be analysed according to the methods explained above and in WO2006/012989. Alternatively, the alcohol mixture may be silylated and analysed by GC or GCMS, a technique that provides a better separation than direct GC or GCMS.

The hydrolysis of the phthalate dialkyl ester may be performed by any method known in the art, but is preferably performed by the method that may be summarised as follows:

Let the ester react with KOH (0.5N in ethanol) at 83-85° C. under reflux for ±4 h.

Cool down to room temperature and filter out the potassium phthalate formed.

Add water to dissolve the excess of KOH and the remaining soap.

Add n-hexane to extract and separate the base alcohol from the ethanol/water phase.

Bubble N₂ through the separated hexane/alcohol mixture, at room temperature, to concentrate the base alcohol.

The C12-C14 alcohols used as the main raw material in the production of the phthalate dialkyl esters according to the invention are preferably primary alcohols, because these lead to esters that are more hydrolytically stable, typically those obtainable by the hydroformylation of olefin mixtures containing dodecenes. Exxal® 13 alcohol, having the typical composition as described in Table 1, was found to be a suitable starting alcohol. A suitable starting olefin mixture is propylene tetramer, obtained by oligomerisation of propylene over a suitable acid catalyst, such as solid phosphoric acid or a zeolite. The Exxal® 13 alcohol may be derived from a propylene tetramer that was produced over solid phosphoric acid catalyst. Suitable C12 olefins may also be obtained by the oligomerisation of butenes, selected from isobutene, butene-1, cis-butene-2 and trans-butene-2, and mixtures thereof. Preferred are mixtures of primarily n-butenes, such as raffinate-2, obtained from the C4 fraction obtained from steamcracking, catalytic cracking, coking or flexicoking, from which most of the acetylenes, butadiene and isobutylene have been removed. Butenes may be oligomerised to the suitable dodecene mixtures using solid phosphoric acid or zeolite catalysts, or using nickel-based techniques known as Dimersol® X from Axens or Octol® from Evonik-Oxeno, or those disclosed in U.S. Pat. No. 7,300,966 B2. The olefin feedstocks for the C12-C14-alcohols obtained by hydroformylation may also be derived from the Shell Higher Olefins Process (SHOP), or from the Fischer-Tropsch or gas-to-liquids process, such as described in EP 835234, but many other disclosures in this field, such as also on coal-to-liquids, may readily be found.

Suitable processes to produce oxo alcohols having from 6 to 15 carbon atoms per molecule are disclosed in numerous publications, more particularly in WO 2005/058782, WO 2005/58787, WO 2008/128852, WO 2008/122526, WO 2006/086067 and in our copending patent applications PCT/EP2009/005995 and PCT/EP2009/005996. Some of these processes employ the so-called “Kuhlmann” cobalt catalyst cycle, such as the process disclosed in WO 2008/122526, and this catalyst cycle produces an acidic waste water stream from which most of the cobalt has been removed as HCo(CO)₄, by stripping and/or by extraction. As already explained in WO 2008/122526, we prefer to further reduce the cobalt content of such acidic waste water stream before disposal of the stream. For this purpose, we prefer to bring this water, typically using concentrated caustic soda, to a pH in the range of 10.5 to 13.0, at which the solubility of Co(OH)₂ is the lowest. Any Co(OH)₂ precipitates out and forms a sediment in the downstream clarifier. Due to the small size of cobalt hydroxide particles, long residence times and typically also addition of a flocculant is highly desirable to ease this sedimentation step. The water from the clarifier may additionally be passed through a filter, such as a sand filter, to remove the last traces of cobalt solids. Its pH may then again be reduced to within a range between 6 and 9, preferably by using CO₂ injection because this is self-buffering, after which it may be routed to a biological oxidation (BIOX) unit for removal of organics, and after which it may be discharged.

Other process waste water streams, as well as rain water, may also require treatment for reducing their organics content, and we prefer to combine these organics containing waste water streams upstream of a single BIOX unit because of the reduced process complexity and the savings in investment cost compared to running separate BIOX units in parallel. The BIOX reactor effluent typically passes to a clarifier in which the biomass settles by gravity and the clean water leaves via an overflow baffle. We have now found that floating layers of biomass may occasionally develop in the clarifier, which cause the overflowing water to go off-spec on Chemical Oxygen Demand (COD) and/or on Total Suspended Solids, two important quality requirements for waste water that is to be disposed. We believe that this problem is primarily caused by a high salt content of the water entering the BIOX reactor, and that this problem is not limited to the particular reactor described here. To prevent violations of the environmental permit, it may then be necessary to store the contaminated water from the clarifier until the floating layer problem has been resolved. When the available storage facilities are full, this may thus possibly lead to a forced shutdown of the production facilities.

We have found that when the total salt content of the water entering a BIOX reactor, and particularly the BIOX reactor discussed above, is maintained at a level below 2 wt %, and preferably is kept fairly constant such as in the range of 0.5-2.0 wt %, more preferably in the range of 1.0-1.9 wt % and even more preferably in the range of 1.5-1.8 wt %, that the occurrence of floating layers on the clarifier downstream of the BIOX reactor is significantly reduced, and even essentially eliminated.

We have found it convenient for this purpose to monitor the electrical conductivity of the waste water entering the BIOX reactor using a conductivity analyzer, and we prefer to control the conductivity of that water to at most 20 milliSiemens (mS), preferably in the range of 15-18 mS.

Any suitable means for controlling the salinity or the conductivity of the BIOX reactor feed water may be employed. We have observed that the process water coming from the cobalt cycle of the hydroformylation process is fairly constant in flow rate and in salt content, but typically high in salt content. Other water streams to be treated, and particularly rain water streams, are typically much lower in salt content, and their flow rate may be more variable. We therefore find it advantageous to control the ratio at which these other low-salt streams are mixed into the high salt containing process water from the cobalt cycle, upstream of the BIOX reactor, preferably in combination with temporary storage of any excess of the low-salt water streams. When insufficient low-salt waste water volume is available, extra service water, typically having a low salt content, may be introduced. We have found that by the introduction of this salt content control, the occurrence of floating layers in the BIOX clarifier could be reduced from about 50 per year down to less than 3 per year.

The phthalate dialkyl ester composition produced by the process of the present invention comprises as a major component a phthalate diester with both alkyl groups having an average carbon number of from 12 to 14, such as the ester or the mixture of esters derived from the C13 alcohols described hereinabove. The major ester component is preferably present in at least 50% or at least 56% by weight, based on the total weight of all the esters in the composition, more preferably at least 70% by weight, even more preferably at least 85% or at least 90% by weight, yet more preferably at least 93% and even more preferably at least 96% by weight. Even more preferably, the major ester component of the present invention is a phthalate dialkyl ester with both alkyl groups having a nominal average carbon number of 13, and yet more preferably having a carbon number of 13.

In an embodiment of the invention, the phthalate dialkyl ester composition comprises less than 50% by weight, preferably less than 35%, 27%, 18% or 9% by weight of a phthalate dialkyl ester of which at least one alkyl group is having less than 12 carbon atoms.

The alkyl groups of the major component in the product of the present invention may be linear, such as comprising, or consisting of, n-tridecanol, or they may be branched, such as with isotridecanol derived as disclosed in U.S. Pat. No. 7,300,966 B2. We prefer that the alkyl groups of the major component comprise at least 50% by weight of alcohols having 13 carbon atoms, the percentage being expressed as C13 alcohols and relative to the total weight of alcohols that is obtained upon saponification of the C13 phthalate ester composition of the invention. We prefer that the alcohols obtained upon saponification comprise at least 60% by weight, more preferably at least 70%, even more preferably at least 80%, yet more preferably at least 90% and most preferably at least 95% or even 96% by weight of alcohols having 13 carbon atoms. The amount in the mixture of alcohols having 13 carbon atoms may be determined by first preparing the trimethylsilyl ether derivatives, followed by analysis by GC-MS for determination of the molecular weight of each peak. Quantification may then be done using standard GC-FID.

In an alternate embodiment, the average or nominal average carbon number of the phthalate dialkyl ester composition produced by the process of the present invention may be determined using ¹H-NMR on the total composition. The analysis may be performed on the alcohol after hydrolysis, but we prefer to do the analysis on the ester mixture itself, because the additional hydrogen atoms introduced by the acid function into the ester are on the aromatic ring. Their signal is separated from the hydrogen atoms in the alkyl chains and may be readily discarded, ignored or discounted for. This direct analysis method of the ester we have found works evenly well and avoids the need for the extra saponification step.

Titanium residues in plasticisers have been found to result in colour formation in the plasticisers during storage particularly if heating is required during storage, as may be required in cold climates, or in the case of higher molecular weight plasticisers such as the C13 phthalate ester compositions produced by the process of the present invention.

Antioxidants such as phenolic antioxidants are typically incorporated into plasticiser esters which are to be stored and used in particular end uses such as wire and cable production. We have found that colour formation may occur, despite the presence of antioxidant, if the plasticiser contains titanium residues. This is thought to be due to interaction of the titanium with the antioxidant. Although the thermal stability of the plasticiser is not significantly affected, the discoloration of heated plasticiser may create problems for the PVC compounding and cable industry, in particular when making white or transparent compounds.

In one embodiment of the present invention, the phthalate dialkyl ester compositions produced by the process of the invention may contain less than 2 ppm, preferably less than 1 ppm, more preferably less than 0.5 ppm by weight of titanium, even more preferably less than 0.2 ppm or 0.1 ppm, yet more preferably less than 0.05 ppm and most preferably less than 0.01 ppm by weight of titanium. We have found that by providing such low titanium levels in the ester product, colour formation in the presence of an antioxidant may be substantially reduced or even avoided. Techniques for obtaining such low titanium contents are disclosed in WO 2006/125670. The titanium content is typically determined by ICP-AES (Inductively Coupled Plasma Atomic Emission Spectrometry).

In a further embodiment, the phthalate dialkyl ester composition produced by the process of the present invention may contain from 0.1 to 2.0 wt % of an antioxidant. The antioxidant content is conveniently determined by HPLC (High Performance Liquid Chromatography). We prefer to use a Waters 2695 separation module, equipped with a Nova-Pak C18 60 Angstrom 4 micrometer (3.9×150 mm) column and a Photodiode Array Detector. We prefer to use 278 nm as testing wavelength, where most typical antioxidants give a convenient reading. The mobile phase and operating procedure may be adapted to the nature of the antioxidant that is being analysed for. Either an isocratic run or a gradient run may be used. For many of the typical antioxidants we prefer to use a gradient run with a flow rate of 1 ml/min, and as mobile phase an 80/20 or 90/10 vol % methanol/water mixture for the first 2.5 minutes at the start of the run and for the last 3 minutes at the end of the run, separated by a 100% methanol mobile phase for the 12.5 minutes middle section of the run. When isocratic runs are carried out, we prefer to operate with 100% methanol as mobile phase at a flow rate of 2 ml/min for the full run. Quantification may conveniently be done with reference to an external standard that is prepared and analysed separately.

In one embodiment, we use from 0.1 to 2.0 wt %, more preferably 0.15 to 1.5 wt %, even more preferably 0.2 to 1.25 wt % of the antioxidant, the most preferred level depending upon the type of antioxidant, and we further prefer that the antioxidant is a phenolic antioxidant. Examples of preferred antioxidants are compounds such as di-tert-butyl hydroxy toluene or “butylated hydroxytoluene” (BHT), “butylated hydroxy ethylbenzene (BHEB), or the following compounds: Bis-phenol-A (BPA), diphenylolpropane or 2,2-Bis (p-hydroxyphenyl)propane); Topanol CA (TCA, or 1,1,3-tris(2-methyl-4-hydroxy-5-t-butylphenyl)butane); Topanol CA-SF (Topanol CA with low solvent content or “solvent free”, by Vertellus); Irganox® 1010 (tetrakis-(methylene (3,5-di-t-butyl-4-hydroxyhydrocinnamate) methane); Irganox® 1076 (octadecyl-3,5-di-t-butyl-4-hydroxyhydrocinnamate); Irganox 1135 (benzenepropanoic acid, 3,5-bis(1,1-dimethyl-ethyl)-4-hydroxy-C7-C9 branched alkyl esters); Irganox® 1141 (2,4-dimethyl-6-(1-methylpentadecyl)-phenol); tris-(3,5-di-tert-butyl-4-hydroxybenzyl)isocyanurate; tris-(4-tert-butyl-3-hydroxy-2,6-dimethylbenzyl)isocyanurate and 1,3,5-[tris(para-4-hydroxy-3,5-tert-butyl benzyl]2,4,6-trimethyl benzene. Examples of preferred mixtures are DTDP with 0.3 wt % Topanol CA-SF and DTDP with 1.0 wt % BPA.

For the production of an antioxidant containing mixture, a concentrated or mother solution may be prepared by dissolving Topanol CA-SF or BPA into the DTDP plasticizer at typically a 5-10% concentration. The plasticizer ester may be heated to 80-90 degrees C. under nitrogen to accelerate the dissolution of the antioxidant into the plasticizer and to lower the viscosity of the mixture. The mother solution may subsequently be dosed on ratio and mixed into the neat plasticizer before transferring to the storage tank, or to the ship or to the tank truck. The use of Topanol CA-SF as the oxidant for DTDP may be preferred as it only requires 3-6% of the total volume to be mixed with the 5-10 wt % mother solution, whereas for BPA as antioxidant the addition of 10-20% of the total volume as 5-10 wt % mother solution would require the handling of much larger liquid volumes.

For other plasticizer products, such as DINP, DIDP or DIUP, we prefer to add a 10 wt % BPA in DIDP solution to the plasticizer.

The process for the production of the phthalate dialkyl ester compositions according to the present invention conveniently uses as catalyst a tetra-alkyl titanate that is tetra-n-butyl titanate. Even more preferably, the process employs a titanate wherein the alkyl groups have an average carbon number of at least 5. Yet more preferably the alkyl groups in the titanate have an average carbon number of at least 7.9 and/or at most 9.3, and more preferably have a nominal average carbon number of 8, 9 or 10. In this series we prefer 8 for the reasons mentioned above, but 9 and 10 are also suitable. Very suitable titanates are tetra-iso-octyl titanate, tetra-2-ethyl-hexyl-titanate, tetra-isononyl titanate, tetra-2-propyl-heptyl titanate, and mixtures thereof. Most preferred is tetra-iso-octyl titanate.

The process may be performed by methods that are further known in the art. We prefer to use a process as described in, for example, WO 2005/021482, WO 2006/125670, WO2008/110305, or WO2008/110306.

In one embodiment, we use a temperature and pressure profile during the esterification reaction, and a titanium catalyst addition procedure, as explained in WO2008/110306, wherein these parameters are optimised in order to minimise esterification batch time and to maximise the effectiveness of the catalyst and of the heat input to the reaction. In another embodiment, the esterification process according to the present invention is conveniently performed in the manner described in WO2008/110305, wherein the esterification recipe and the feed pretreatment are optimised in order to optimise the reaction rate and to reduce reaction time. A particularly convenient reaction cycle for the production of esters and in particular plasticiser esters comprises this feed recipe adjustment and pretreatment followed by the employment of the reaction process of WO2008/110306, followed by the neutralisation technique published in WO2006/125670 and the purification techniques of WO2005/021482.

The reaction is typically conducted using a 5 to 30 molar % excess of alcohol. More preferably, a 15 to 30 molar % excess of alcohol is used.

In one embodiment of the reaction cycle, alcohol is preheated to a temperature in the range 100° C. to 160° C. For C11 or higher alcohols, such as isotridecyl alcohol, we use 130° C.-155° C. or even 160° C. The preheated alcohol is then conveniently added to a reaction vessel that is blanketed with an inert gas, preferably nitrogen or methane, and the reaction vessel may be heated at a temperature in the range 120° C. to 150° C. or 160° C. and may be at atmospheric pressure. Maximum heat input to the reactor is preferably applied as soon as possible. The acid or acid anhydride is then added at a temperature in the range 135° C. to 160° C. or even up to 180° C. The content of the reaction vessel is then rapidly heated to the predetermined mixture temperature at which the catalyst is added. As the contents of the reactor increases, the pressure will increase by compression of the inert gas in the reactor. The pressure will also increase due to vaporisation of some of the reactants and products of reaction, forming a vapour cloud of condensables above the reactor liquid. The predetermined mixture temperature depends upon the nature of the catalyst and the reactants but is typically in the range 175° C. to 220° C. When this temperature is reached, the catalyst is introduced. The temperature is then typically further increased to the desired esterification reaction temperature, typically in the range 210° C. to 230° C., with continuing increase in pressure due to the vaporisation of materials. As the vapour cloud of condensables reaches the condenser, condensation starts and soon thereafter the reflux system is activated. Preferably at that moment, additional inert gas may be provided, if required, to restore the pressure and to minimise condensation and reflux of reactant to the reactor, as well as the vaporisation from the reacting liquid mixture. This longer maintenance of the pressure further increases the effectiveness of the heat provided to the reaction mixture by minimising cold reflux from the overhead system back to the reactor.

The reaction temperature conveniently is as close as possible to the 220° C. upper limit for titanium catalyst activity and stability, while the control set point on reactor pressure is pushed down to enable rapid removal of vapours whilst maintaining the temperature, the speed of which is dependent on the heat input capabilities. If the reaction temperature declines away from its target, the pressure set point reduction slope may be temporarily overridden to allow the temperature to regain its previous level, after which the pressure set point may again be allowed to drop. The temperature decline that triggers the override is grade dependent but is typically no more than 2° C., preferably no more than 1° C.

When the desired esterification reaction temperature or temperature range is reached, the pressure in the reaction vessel is preferably rapidly reduced to below atmospheric pressure, while the temperature is typically at least maintained at the minimum desired esterification reaction temperature. This rapid reduction in pressure may be accomplished by opening the vent valve and/or by pulling vacuum on the reactor using a steam jet, an air jet, or a vacuum pump. Water and the unreacted excess reagent (typically the C13 alcohol in the preferred embodiment) will vaporise, pass to the condenser where they most of these are typically condensed and separated. The unreacted reagent may then be recycled to the reactor, preferably passing through a reflux column and/or other drier and/or heating step prior to re-entering the reactor.

The total amount of catalyst that should be used in the process of the current invention is determined primarily by four factors. First, the total reaction rate generally increases as the amount of catalyst, typically expressed in weight percent of catalyst per weight of limiting reactant, increases up to a certain optimal concentration. The reaction rate also depends on the particular catalyst activity, the reaction temperature and the water content of the reaction mixture. A relatively high concentration of catalyst may result in the organometallic complex esterification catalyst reacting with itself, to form an inactive agglomerated catalyst. Furthermore, a relatively higher concentration of certain esterification catalysts can cause product haze formation. In addition, process economics dictate that beyond an optimal point, further catalyst addition is not economical. If the reaction mixture contains an appreciable amount of certain cationic species, then the catalyst requirement must be increased to reach a desired reaction rate. The amount of catalyst used will therefore be chosen having taken all these factors into consideration.

The esterification process of the present invention may also include one or more of the following steps: removal of excess reagent by nitrogen or steam stripping; addition of adsorbents such as alumina, silica gel, activated carbon, clay and/or filter aid to the reaction mixture following esterification before further treatment. In certain cases adsorbent treatment may occur later in the process, following stripping, and in still other cases the adsorbent step may be eliminated from the process altogether. Addition of water and base to simultaneously neutralize the residual organic acids and hydrolyze the titanium catalyst; filtration of solids from the ester mixture containing the bulk of the excess alcohol used in the esterification process; removal of the excess reagent from the ester mixture by, for example steam or nitrogen stripping under vacuum and recycling of the excess reagent to the reaction vessel; and, removing solids from the stripped ester in a final filtration, may also be included in the process of the present invention.

We prefer to produce the C₁₃ phthalate ester of the present invention on a processing unit that also produces other esters, in particular other phthalate esters, also called product or ester grades, such as di-isoheptyl phthalate (DIHP), di-isooctyl phthalate (DIOP), di-isononyl phthalate (DINP), di-isodecyl phthalate (DIDP), di-isoundecyl phthalate (DIUP) and/or (iso)undecyl (iso)dodecyl phthalate (UDP). When switching from the production of a first ester grade to the production of a second ester grade, we prefer to use the grade switch procedure disclosed in WO2008/110304. The so-called “flying grade switch” procedure disclosed therein in great detail is particularly suitable for switching between two phthalate ester production runs. When starting the production of the C13 phthalate ester of the present invention, the previous production run may be of any other ester, but preferably of a phthalate ester, more preferably of any of the phthalate esters mentioned above. We have found that, when the second ester in the flying grade switch procedure is the C13 phthalate ester of the present invention, and the first ester in the procedure is a phthalate with both alkyl groups having at least 9 carbon atoms, small amounts of cross-contamination of the first phthalate ester into the C13 phthalate ester of the present invention have a smaller contribution to the sensitive volatility tests as compared to the C3-C13 co-ester of which the present invention desires to control and/or minimise the concentration and the effect. We prefer that the first phthalate ester is an ester with both alkyl groups having at least 10, more preferably at least 11 carbon atoms. We prefer that the first ester is DIUP, UDP or DIDP. We most prefer that the first ester is DIDP, because this phthalate ester is used in many more end-uses than DIUP or UDP, so that the production runs are longer and the volumes produced per production campaign are larger. With the typical larger campaign volume for DIDP, the same amount of contamination with another ester, such as a C13 phthalate of the present invention, represents a smaller concentration in the final DIDP product, such that any effects due to the contamination are minimised. We have found that the amount of cross-contamination between the first phthalate ester and the second phthalate ester may be controlled by close monitoring and an appropriate selection of the time to switch the outlet of the continuous finishing section to a new product tank. We prefer to operate such that the amount of cross-contamination between the first ester, preferably DIDP, and the second ester, in this case DTDP, is less than 1% wt of the products made during the entire campaigns of the first ester, of the second ester, and/or again of the ester produced after the campaign of the second ester, and which may be the same ester as the first ester. We prefer to operate such that the DTDP produced in the campaign and according to the invention contains at most 0.8% by weight, preferably at most 0.6% or 0.5% by weight, more preferably at most 0.45% or at most 0.4% by weight, and most preferably at most 0.35% or 0.3% by weight of the first ester, preferably DIDP. On the other hand, we prefer to operate such that the first ester, which preferably is DIDP, contains at most 0.8% by weight, more preferably at most 0.7% or 0.6% by weight and most preferably at most 0.5% by weight of the DTDP of the current invention.

The esterification reaction between an alcohol and an acid or its anhydride produces water as a byproduct. The esterification processes for the production of a phthalate, an adipate, a trimellitate, a cyclohexanoate or a di-cyclohexanoate ester, of a C6 to C15 alcohol as described herein, therefore comprise typically several locations where free water and organics are separated by gravity. One such location is the separator in the overhead of the reactor, in which, after condensation, water byproduct from the reaction is separated from the alcohol that is also boiling off from the reaction mixture. At the end of an esterification reaction, typically remaining acidity in the crude ester product is neutralised by contacting with a dilute base, and/or the titanate catalyst may be hydrolised by adding water. In a “wet” process, this may result in a free water phase which needs to be separated, possibly after one or more filtration steps to remove solids, such as titanium hydroxide and/or titanium dioxide, from the hydrolised reaction product. An extra water wash stage, including a second water separation step, may also be included. We have found that in these separation steps for removing free water from alcohol or crude ester product, organic/water emulsions may be formed, which may cause throughput limitations in the downstream ester finishing process, as well as extra organics losses into the separated waste water.

We have also found that the formation of these emulsions may be greatly reduced or even eliminated by injection of an aqueous solution of a salt in combination with a demulsifier. We prefer to use as demulsifier a polyquaternary amine chloride, preferably in an aqueous solution such as the generically called demulsifier “Breaxit” obtainable from Nalco/Exxon Energy Chemicals as product EB2098A. Any salt may be suitable, and we prefer to use sodium sulfate as the salt. For reducing emulsion formation in the esterification reactor overhead, we conveniently prepare a solution of 1-1.25 wt % of sodium sulphate in water, which is then used for the dosing. A typical dosing level is in the range of 2.5-5.0% wt of this dosing solution relative to the organic/water stream, which typically is an 80/20 weight mixture of alcohol/water. In the “wet” titanium process, wherein the crude ester is neutralised with a dilute alkaline solution, thereby also hydrolising the titanate catalyst, the combination of neutralised crude ester and associated water phase is filtered, after filtration the organic crude ester phase is separated from the free water phase in a settler and passed through an additional water wash step to remove most of the salt of the mono-ester, we conveniently reduce emulsion formation in the settling and the washing step by dosing in the “Breaxit” demulsifier EC2098A. The demulsifier is obtained as a solution containing 22.2% wt active material in water, and the solution is added into the feed to the wash section at a weight ratio of 25-100 ppm on the hydrocarbon feed, typically at a level of 50 ppm.

The crude ester finishing process typically contains a stripping step for the removal of most of the excess alcohol used in the reaction. Also dissolved water is removed in this stripping step. The stripping may conveniently performed by steam stripping. The vapors from the stripping operation are usually condensed, typically leading to the formation of two liquid phases, an organic (alcohol) phase and a free water phase, which also require separation. The alcohol is typically recovered for at least partial but preferably full reuse in the reaction, while the condensate may be reused in the upstream hydrolysis step, if present, or as wash water, or it may be passed on for waste water treatment.

We have found that also in this separation step emulsions may be formed, which lead to entrained water being recycled to the esterification reaction, extra alcohol recycle over the hydrolysis, washing and stripping steps, and/or to increased organics in the waste water. In particular phthalate mono-esters, which may still be present at this stage, and thus may end up in the waste water going to a biological oxidation (BIOX) waste water treatment, are problematic because of their tendency to form aerosols, which have an obnoxious odour.

We have now found that the alcohol/water settling step in the stripper overhead system may be improved by carefully controlling the temperature of the separator within a narrow optimal range. Lower temperatures often lead to emulsion formation, and at higher temperatures the amount of alcohol dissolved in the water increases. The optimal separation temperature range typically depends on the type of alcohol. For iso-heptyl alcohol we prefer the separator to operate in a temperature window of 25° C.-35° C., more preferably of 27° C.-30° C. We find it convenient to control the separator temperature by controlling the coolant to the condenser, and/or by heating the separator feed.

The invention further provides for forming an article which comprises PVC plasticised with the C13 phthalate ester composition produced by the process according to the invention. Examples of such articles are interior trim parts or a soft touch parts or covers for the automotive, boat or aeronautic industry, such as a dashboard or dashboard cover, an ABC column or ABC pillar cover, whereby A refers to the columns aside the windscreen, B refers to the connection to the roof in between the front seats and the back seats, and C refers to the connections aside the rear window, a sun visor, an armrest, a middle console part or cover, a door panel or a door trim cover or article, a steering wheel cover, an airbag door cover, a gear shift handle cover, a seat cover or a back seat cover, a headliner, which covers the inside of the roof, a rear or parcel shelf, or for an electrical cable comprising electrical insulation. The invention also provides for producing a compound prepared as an intermediate in the production of such article, and which comprises PVC plasticised with the C13 phthalate ester composition according to the invention. The article may be formed using one or more techniques known in the art, such as spread coating, calendaring, extrusion, blow moulding or injection moulding.

Flexible polyvinyl chloride (PVC) in general finds significant use in electrical insulation, in particular as insulation for electrical cables. A wide variety of plasticizers are used in such applications, and the Wire and Cable (W&C) industry prefers to use esters that bring an enhanced permanence, in particular a lower volatility. Trimellitates are therefore preferred, but a suitable alternative is also provided with higher molecular weight phthalates, such as DINP, DIDP, DIUP, UDP and DTDP, including the C13 phthalate ester of the present invention.

The flexible PVC formulations typically contain a stabilizer, and traditionally lead stabilizers, such as dibasic lead phthalate or tribasic lead sulphate, have been used. Lead stabilizers have been preferred because they provide good long-term wet insulation resistance. They scavenge any HCl, which becomes liberated from PVC hydrolysis, by forming lead chlorides which are water insoluble, and this hydrolysis-resistant environment effectively interferes with water-induced increases in conductivity.

Wire and cable manufacturers who wish to switch away from lead stabilizers find it difficult to develop a non-lead PVC compound that meets the required cable performance in terms of long term dielectric loss, such as the Industry Standard UL 83 criteria for products such as Thermoplastic High Heat-resistant Nylon-coated (THHN) or Thermoplastic High Water-resistant Nylon-coated (THWN) cables, which require a lengthy water immersion insulation resistance test. Non-lead stabilizers for wet applications typically scavenge the HCl with hydrotalcite or hydrotalcite-like substances, and the reaction with HCl usually generates CO2 and chlorides of aluminum, calcium and/or zinc, all of which are water soluble. During water immersion, these water soluble reaction products leach from the cable and are partly replaced by water molecules due to moisture diffusion, which increases the water content in the insulation and decreases the insulation resistance. Flow paths form, called voids, in which current-conducting hydrated chloride ions are formed, resulting in current leakage.

We have now found that the formation of these flow paths during water immersion can be significantly reduced, and wet insulation resistance thereby improved, by selecting a filler having particular properties. Aluminum silicates or clays are popular fillers used in W&C formulations. A first way to reduce such flow path formation is by using a nanoparticle clay. Platy clay nanoparticles are believed to become oriented during the extrusion of the flexible PVC compound, and we have found that this reduces leaching of insulation components from the cable or compound into water. The result is a decrease in insulation resistance that remains acceptable, and thus an improved performance in the water immersion insulation resistance test. The nanoparticle clay also helps in blocking the leaching of non-lead stabilizer molecules, resulting in less current leakage. We have found that the moisture diffusion into the insulation may further be reduced by using nanoclays that have been surface treated to enhance their hydrophobicity. A second way to reduce such flow path formation during water immersion is by using a hydrophobic clay. The hydrophobicity of the clay reduces water diffusion, and the result is a decrease in insulation resistance that remains acceptable, and thus an improved performance in the water immersion insulation resistance test. The reduced solubilization of the clay also helps in blocking the leaching of non-lead stabilizer molecules, resulting in less current leakage. Clays may be surface treated to render it hydrophobic for instance by treatment with vinyl silanes. An example of such silane modified clay is Burgess KE, available from Burgess Pigment Company, Georgia, U.S.A.

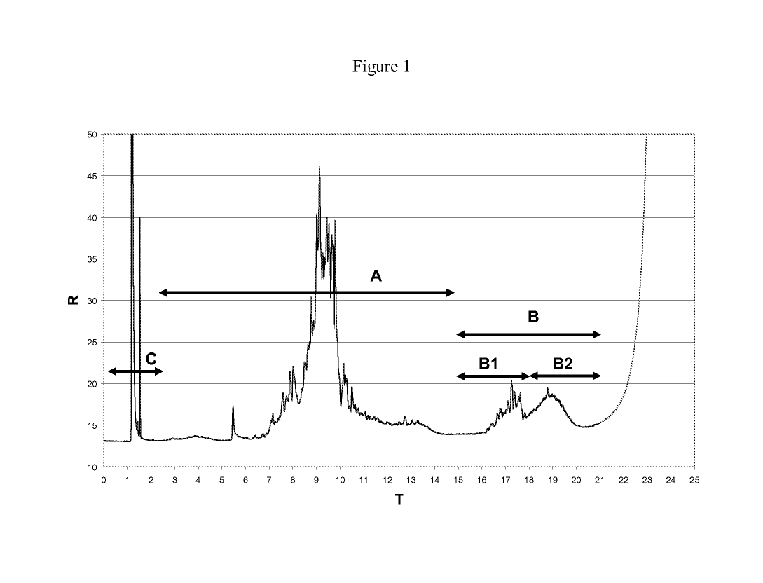

FIG. 1 shows a light ends gas chromatogram spectrum of a di-isotridecyl phthalate produced from Exxal 13 alcohol available from ExxonMobil Chemical. The graph shows response intensity (R) in the ordinate against elution time (T) in minutes in the abscissa. The main phthalate ester peak starts at an elution time of 22 minutes. The light ends section shows peaks in region C of the isopropanol diluent that was added to the sample to reduce the sample viscosity for the analysis. In region A, a total of 2900 ppm wt of leftover parent alcohol and phthalic acid and/or anhydride are also shown. Region B shows about 800 ppm by weight total of peaks of what are called “intermediates”, i.e. dimeric compounds such as traces of benzoates, coming from benzoic acid impurities in the phthalic anhydride, here primarily found in region B1, but in region B2 also di-alkyl ethers of the parent alcohol molecules or di-alkyl esters of such alcohol with an acid molecule derived therefrom. The quantification of the content of these components is preferably facilitated by using an internal standard, such as explained for FIG. 2 in WO 2005/021482.

As an example of the present invention, Exxal 13 alcohol available from ExxonMobil Chemical was esterified with phthalic anhydride using TIOT as the esterification catalyst, and following the esterification processes described in WO 2008/110305, WO 2008/110306, WO 2006/125670 and WO 2005/021482. A sample of the product DTDP was saponified using the technique described above, and the alcohol fraction was separated. A sample of the alcohol fraction was submitted to silylation and to Gas Chromatography. The GC spectrum showed in the light ends region with a retention time in the range of 26-31 minutes a series of peaks for a total of about 1400 ppm by weight. Due to their retention times, these peaks can be associated with iso-octyl alcohol molecules, which are originating from the TIOT catalyst that was used in the esterification process.

Having now fully described this invention, it will be appreciated by those skilled in the art that the invention can be performed within a wide range of parameters within what is claimed, without departing from the spirit and scope of the invention.

What is claimed is:

1. A process for producing a phthalate dialkyl ester composition comprising the reaction of phthalic acid and/or phthalic anhydride with an alcohol or alcohol mixture having a nominal average carbon number in the range from 12 to 14 in the presence of a tetra-alkyl titanate esterification catalyst of formula Ti(OR)₄ in which the R groups are alkyl groups having a nominal average carbon number of at least 4.

2. The process according to claim 1, wherein the tetra-alkyl titanate catalyst is substantially free of propyl alcoholate groups.

3. The process according to claim 1, wherein the alkyl groups of the tetra-alkyl titanate catalyst are at least 25% by weight primary alkyl groups.

4. The process according to claim 1, wherein the R groups are alkyl groups having a nominal average carbon number of at most 10.

5. The process according to claim 1, wherein the tetra-alkyl titanate is tetra-n-butyl titanate.

6. The process according to claim 1, whereby the phthalate dialkyl ester product composition comprises as a major component a phthalate dialkyl ester, in which both alkyl groups of the ester functions have a nominal average carbon number of from 12 to 14, said composition, relative to the total weight of the composition, and the composition further comprises:
(i) less than 500 ppm by weight of a phthalate dialkyl ester having a propyl group as at least one of the alkyl groups of the ester functions; and
(ii) from 10 to 2500 ppm by weight of a phthalate dialkyl co-ester in which one of the ester functions has a first alkyl group having a nominal average carbon number of from 12 to 14 and the other ester function has a second alkyl group having a nominal average carbon number of at least 4.

7. The process according to claim 6, wherein the second alkyl group in (ii) has a nominal average carbon number of at least 5.

8. The process according to claim 1, wherein the R groups of the tetra-alkyl titanate catalyst are alkyl groups having a nominal average carbon number of at least 5.

9. The process according to claim 8, wherein the R groups of the tetra-alkyl titanate catalyst are alkyl groups having a nominal average carbon number of 8, 9 or 10.

10. The process according to claim 8, wherein the R groups of the tetra-alkyl titanate catalyst are alkyl groups containing at most 1% by weight of 2-ethyl-hexyl groups, relative to the total of the alkyl groups of the tetra-alkyl titanate catalyst.

11. The process according to claim 1, wherein the alkyl groups having a nominal average carbon number of from 12 to 14 comprise at least 50% by weight of alkyl groups having 13 carbon atoms, the percentage being expressed as C13 alcohols and relative to the total weight of alcohols that is obtained upon saponification of the phthalate ester composition.

12. The process according to claim 1, further comprising using the phthalate dialkyl ester composition as a plasticizer with polyvinyl chloride (PVC).

13. The process according to claim 12, further comprising shaping a flexible PVC article.

14. The process according to claim 13, wherein the flexible PVC article is comprised in an electrical wire and wherein the flexible PVC article comprises the phthalate dialkyl ester composition either as the sole plasticizer or in blends with other plasticisers, preferably with a total plasticizer concentration in the range of 40-70 parts per hundred resin (phr), and whereby optionally the other plasticizers are selected from di-undecyl phthalate (DUP), nonyl-undecyl phthalate (911P), tri-octyl trimellitate (TOTM), tri-isononyl trimellitate (TINTM), di-isodecyl phthalate (DIDP), di-2-propyl-heptyl phthalate (DPHP) and mixtures thereof.
